(19) United States
(12) Patent Application Publication
(10) Pub. No.: US 2020/0394712 A1
(43) Pub. Date: Dec. 17, 2020

(54) Electricity Retail Trading System and Method for Coupling Wholesale Market

(71) Applicants: Dalian University of Technology, Dalian (CN); Kunming Power Exchange Center Company Limited, Kunming (CN)

(72) Inventors: Gang Li, Dalian (CN); Xuguang Yu, Dalian (CN); Yapeng Li, Dalian (CN); Zebin Jia, Dalian (CN); Chuntian Cheng, Dalian (CN); Huaxiang Cai, Dalian (CN); Ran Chen, Dalian (CN); Yongjun Sun, Dalian (CN)

(73) Assignees: Dalian University of Technology, Dalian (CN); Kunming Power Exchange Center Company Limited, Kunming (CN)

(21) Appl. No.: 16/886,718

(22) Filed: May 28, 2020

(30) Foreign Application Priority Data
May 31, 2019 (CN) 201910466459.3

(51) Int. Cl. G06Q 40/04; G06Q 50/06; G06Q 30/00; G06Q 10/10; G06F 21/31; G06F 16/9535

(52) U.S. Cl. CPC G06Q 40/04; G06Q 50/06; G06F 16/9535; G06Q 10/10; G06F 21/31; G06Q 30/0185

(57) ABSTRACT

Electricity retail trading systems and methods for coupling a wholesale market are disclosed. In some embodiments, an electricity retail trading system includes a user login module, a trade unit management module, a first display module, a wholesale market trade module, a retail preliminary distribution module, a data acquisition and deviation calculation module, a second display module, a deviation transfer trade module, a third display module, a retail final distribution module, and a fourth display module. In other embodiments, an electricity retail trading method includes the following steps: (a) user login, (b) trade unit management, (c) declaration and clearing of wholesale market trade, (d) retail preliminary distribution of electricity retailer, (e) data acquisition and deviation quantity calculation, (f) declaration and clearing of deviation transfer market trade, and (g) retail final distribution of electricity retailer.

### CROSS REFERENCE TO RELATED APPLICATIONS

This application claims priority to Chinese application number 20191046645-9.3 filed on May 31, 2019, the disclosure of which is incorporated by reference herein in its entirety.

### FIELD OF THE DISCLOSURE

The disclosure relates generally to power market trading. More specifically, the disclosure relates to electricity retail trading systems and methods for coupling a wholesale electricity market.

### BACKGROUND

With the deepening reform of China's electricity market, the electricity retail markets have gradually been established and operated in many regions and provinces, which has promoted vigorous development of electricity retailers. Electricity retailers sign retail service contracts with entrusting customers to provide different electricity consumption packages thereto, and thus establish the retail service relationship with entrusting customers within the contract period. Electricity retailers participate in the wholesale market on behalf of entrusting customers to win trade contracts through bid and declaration. In addition, electricity retailers participate in the retail market to carry out reasonable distribution of the trade quantity of electricity to the entrusting customers. As such, the risk of deviation assessment between entrusting customers' actual electricity consumption and trade contracts is reduced, and the effective execution of the retail service contracts is ensured. In order to ensure the organic connection between the wholesale market and the retail market and promote the effective execution of the retail service contracts, it is urgent to implement the fair, open, transparent, and standardized participation of electricity retailers in the wholesale and retail markets.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides an electricity retail trading system for coupling a wholesale market. The system includes a user login module (101), a trade unit management module (102), a first display module (103), a wholesale market trade module (104), a retail preliminary distribution module (105), a data acquisition and deviation calculation module (106), a second display module (107), a deviation transfer trade module (108), a third display module (109), a retail final distribution module (110), and a fourth display module (111).

The user login module (101) is configured for a user to enter login information to log in to the system. The user is authenticated to log in to the system if a verification succeeds. The user is prohibited to log in to the system if the verification fails. The user is selected from the group consisting of an electricity selling entity, an electricity purchasing entity, and a power trading institution. The electricity purchasing entity is selected from the group consisting of an electricity retailer, an entrusting customer, and a general customer. The power trading institution serves as a system administrator to control a beginning and end of each step.

The trade unit management module (102) is connected to the user login module (101), and the trade unit management module (102) is configured for the selling and purchasing entities to set up and manage a bid and declaration unit to participate in a market trade. The electricity selling entity serves as a trade unit by combining some or all units of a power plant; among the electricity purchasing entity, the general customer serves as a trade unit by a single account or multiple accounts, and the electricity retailer serves as a trade unit by combining some or all entrusting customers.

The first display module (103) is connected to the trade unit management module (102), and the first display module (103) is configured for displaying the information of the bid and declaration unit set up by the electricity selling and purchasing entities.

The wholesale market trade module (104) is connected to the trade unit management module (102) for wholesale market declaration and clearing. The selling and purchasing entities participate in the wholesale market declaration based on a respective trade unit, the electricity selling entity declares a quantity of electricity to supply and an intended price to sell electricity, the electricity purchasing entity declares demand for electricity and an intended price to purchase electricity, the quantity of electricity declared by the electricity selling and purchasing entities does not exceed a bid quantity thereof, and the electricity trading institution clears the wholesale market based on the market declaration information to form a wholesale market trade result of the electricity selling and purchasing entities.

The retail preliminary distribution module (105) is connected to the user login module (101) and the wholesale market trade module (104). The retail preliminary distribution module is configured for the electricity retailer to distribute a quantity and price to the entrusting customer based on a wholesale market trade contract and a retail service contract with the entrusting customer before an actual electricity consumption cycle starts, so as to guide the customer's electricity consumption, the entrusting customer queries a distribution contract of the trade, the quantity and price of electricity are agreed in the contract, the distribution completed by the retail preliminary distribution module (105) is preliminary distribution, and the preliminary distribution of the electricity retailer meets the following requirements.

(1) Equilibrium Constraint of Preliminary Distribution

Σₙ₌₁^{N}eₙ^{l}*pₙ^{l}=Σₘ₌₁^{M}^{_{c}}eₘ^{c}*pₘ^{c},

(2) Quantity Constraint of Preliminary Distribution

Σₙ₌₁^{N}eₙ^{l}=Σₘ₌₁^{M}^{_{c}}eₘ^{c},

(3) Price Constraint of Preliminary Distribution

pₙ^{l}≤pₙ^{l}≤p̅ₙ^{l}

pₙ^{l}=min{p₁^{c},p₂^{c}, . . . ,p_{M}_{_{c}}^{c}}

p̅ₙ^{l}=max{p₁^{c},p₂^{c}, . . . ,p_{M}_{_{c}}^{c}}

(4) Non-Negative Constraint of Preliminary Distribution

$$\{ \begin{matrix}{e}_{n}^{l} \geq 0 \\ {p}_{n}^{l} \geq 0\end{matrix} ,$$

In the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, pₙ^{l} and p̅ₙ^{l} are upper and lower limits of the distributed electricity price, and p₁^{c}, p₂^{c}, . . . , p_{M}_{_{c}}^{c} are distributed electricity prices.

The data acquisition and deviation calculation module (106) is connected to the trade unit management module (102). The data acquisition and deviation calculation module (106) is configured for acquiring actual electricity generation or consumption of the electricity selling or purchasing entity and calculating a deviation quantity between the actual electricity generation or consumption and the trade contract based on the trade unit of the electricity selling or purchasing entity. If the actual electricity generation or consumption exceeds the quantity agreed in the trade contract, an excess part forms a positive deviation. If the actual electricity generation or consumption does not reach the quantity agreed in the trade contract, a missing part forms a negative deviation.

The second display module (107) is connected to the data acquisition and deviation calculation module (106), and the second display module (107) is configured for displaying the acquired actual electricity generation or consumption of the electricity selling or purchasing entity and the positive or negative deviation quantity of a corresponding trade unit.

The deviation transfer trade module (108) is connected to the data acquisition and deviation calculation module (106), and is configured for bid, declaration and clearing of a deviation quantity trade. After the actual electricity generation or consumption cycle ends, an electricity selling or purchasing entity with a positive deviation quantity participates in a deviation transfer trade with an electricity selling or purchasing entity with a negative deviation quantity. A party with a positive deviation quantity declares a purchase trade contract to reduce the positive deviation. A party with a negative deviation quantity declares a sales trade contract to reduce the negative deviation. A total trade quantity of the electricity purchasing entity or selling entity does not exceed the deviation quantity thereof. The electricity trading institution clears a deviation transfer market to form a deviation transfer trade result.

The third display module (109) is connected to the wholesale market trade module (104) and the deviation transfer trade module (108), and the third display module (109) is configured for displaying a trade result of the electricity selling or purchasing entity in the wholesale market and the deviation transfer market.

The retail final distribution module (110) is connected with the user login module (101), the wholesale market trade module (104), and the deviation transfer trade module (108). A wholesale market trade contract and a deviation transfer market trade contract of the electricity retailer jointly form a deviation-adjusted trade contract thereof. The electricity retailer distributes a final quantity and price to the entrusting customer based on the deviation-adjusted trade contract to facilitate the smooth development of subsequent financial settlement and other services. The distribution completed by the retail final distribution module (110) is final distribution. The final distribution of the electricity retailer meets the following requirements.

(1) Equilibrium Constraint of Final Distribution

$${\sum }_{n = 1}^{N} min ( {e}_{n}^{h} , {e}_{n}^{f} ) * {p}_{n}^{f} = min ( {\sum }_{n = 1}^{N} {e}_{n}^{h} , {\sum }_{m = 1}^{{M}_{c} + {M}_{t}} {e}_{m}^{c} ) * {p}_{a v g}^{f}$$

$${p}_{a v g}^{f} * {\sum }_{m = 1}^{{M}_{c} + {M}_{t}} {e}_{m}^{c} = {\sum }_{m = 1}^{{M}_{c} + {M}_{t}} {e}_{m}^{c} * {p}_{m}^{c}$$

(2) Quantity Constraint of Final Distribution

$${\sum }_{n = 1}^{N} {e}_{n}^{f} = {\sum }_{m = 1}^{{M}_{c} + {M}_{t}} {e}_{m}^{c}$$

(3) Price Constraint of Final Distribution

pₙ^{f}≤pₙ^{f}≤p̅ₙ^{f}

pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

(4) Non-Negative Constraint of Final Distribution

$$\{ \begin{matrix}{e}_{n}^{f} \geq 0 \\ {p}_{n}^{f} \geq 0\end{matrix}$$

In the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} is a finally distributed electricity price, pₙ^{f} and p̅ₙ^{f} are upper and lower limits of the finally distributed electricity price, p₁^{c}, p₂^{c}, . . . , p_{M}_{_{c}}^{c}, p_{M}_{_{c}}₊₁^{c}, . . . , p_{M}_{_{c}}_{+M}_{ₜ}^{c} are finally distributed electricity prices, p_{avg}^{f} is a weighted average price of all trade contracts of the electricity retailer, and eₙ^{h} is actual electricity consumption of the entrusting customer in a corresponding trade period; and

The fourth display module (111) is connected to the retail preliminary distribution module (105) and the retail final distribution module (110), and the fourth display module (111) is configured for displaying a retail preliminary distribution result and a retail final distribution result of the electricity retailer for the entrusting customer.

In other embodiments, the disclosure provides an electricity retail trading method for coupling a wholesale market using an electricity retail trading system. The method includes the following steps.

Step (a): user login. A user enters login information through a user login module (101) for a verification. The user is authenticated to log in to the system if the verification succeeds. The user is prohibited to log in to the system if the verification fails. The user may include an electricity selling entity. An electricity purchasing entity. And a power trading institution. The electricity purchasing entity may include an electricity retailer. An entrusting customer. And a general customer. The power trading institution serves as a system administrator to control a beginning and end of each step.

Step (b): trade unit management. The electricity selling and purchasing entities set up and manage a bid and declaration unit to participate in a market trade. The electricity selling entity serves as a trade unit by combining some or all units of a power plant. The general customer serves as a trade unit by a single account or multiple accounts. The electricity retailer serves as a trade unit by combining some or all entrusting customers. A first display module (103) displays the information of the bid and declaration unit set up by the electricity selling and purchasing entities.

Step (c): declaration and clearing of wholesale market trade. The selling and purchasing entities participate in the wholesale market declaration based on a respective trade unit.

The electricity selling entity declares a quantity of electricity to supply and an intended price to sell electricity. The electricity purchasing entity declares demand for electricity and an intended price to purchase electricity. The quantity of electricity declared by the electricity selling and purchasing entities does not exceed a bid quantity thereof. The electricity trading institution clears the wholesale market based on the market declaration information to form a wholesale market trade result of the electricity selling and purchasing entities. The wholesale market trade result of the electricity selling and purchasing entities is displayed on a third display module (109).

Step (d): retail preliminary distribution of electricity retailer. Before an actual electricity consumption cycle starts, the electricity retailer distributes a quantity and price to the entrusting customer based on a wholesale market trade contract and a retail service contract with the entrusting customer, so as to guide the customer's electricity consumption. The entrusting customer queries a distribution contract of the trade. A fourth display module (111) displays a retail preliminary distribution result. The preliminary distribution of the electricity retailer meets the following requirements.

(1) Equilibrium Constraint of Preliminary Distribution

Σₙ₌₁^{N}eₙ^{l}*pₙ^{l}=Σₘ₌₁^{M}^{_{c}}eₘ^{c}*pₘ^{c},

(2) Quantity constraint of preliminary distribution

$${\sum }_{n = 1}^{N} {e}_{n}^{l} = {\sum }_{m = 1}^{{M}_{c}} {e}_{m}^{c}$$

(3) Price Constraint of Preliminary Distribution

pₙ^{l}≤pₙ^{l}≤p̅ₙ^{l}

pₙ^{l}=min{p₁^{c},p₂^{c}, . . . ,p_{M}_{_{c}}^{c}}

p̅ₙ^{l}=max{p₁^{c},p₂^{c}, . . . ,p_{M}_{_{c}}^{c}}

(4) Non-Negative Constraint of Preliminary Distribution

$$\{ \begin{matrix}{e}_{n}^{l} \geq 0 \\ {p}_{n}^{l} \geq 0\end{matrix}$$

In the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, and pₙ^{l} and p̅ₙ^{l} are upper and lower limits of the distributed electricity price.

Step (e): Data acquisition and deviation quantity calculation. Actual electricity generation or consumption of the electricity selling or purchasing entity is acquired. A deviation quantity between the actual electricity generation or consumption and the trade contract is calculated based on the trade unit of the electricity selling or purchasing entity: if the actual electricity generation or consumption exceeds the quantity agreed in the trade contract, an excess part forms a positive deviation, and if the actual electricity generation or consumption does not reach the quantity agreed in the trade contract, a missing part forms a negative deviation. A second display module (107) displays the acquired actual electricity generation or consumption of the electricity selling or purchasing entity and the positive or negative deviation quantity of a corresponding trade unit.

Step (f): declaration and clearing of deviation transfer market trade. After the actual electricity generation or consumption cycle ends, an electricity selling or purchasing entity with a positive deviation quantity participates in a deviation transfer trade with an electricity selling or purchasing entity with a negative deviation quantity. A party with a positive deviation quantity declares a purchase trade contract to reduce the positive deviation. A party with a negative deviation quantity declares a sales trade contract to reduce the negative deviation. A total trade quantity of the electricity purchasing entity or selling entity does not exceed the deviation quantity thereof. The electricity trading institution clears a deviation transfer market to form a deviation transfer trade result. The deviation transfer trade result is displayed on the third display module (109).

Step (g): retail final distribution of electricity retailer. A wholesale market trade contract and a deviation transfer market trade contract of the electricity retailer jointly form a deviation-adjusted trade contract thereof. The electricity retailer distributes a final quantity and price to the entrusting customer based on the deviation-adjusted trade contract to facilitate the smooth development of subsequent financial settlement and other services. The fourth display module (111) displays a retail final distribution result. The final distribution of the electricity retailer meets the following requirements.

(1) Equilibrium Constraint of Final Distribution

$${\sum }_{n = 1}^{N} min ( {e}_{n}^{h} , {e}_{n}^{f} ) * {p}_{n}^{f} = min ( {\sum }_{n = 1}^{N} {e}_{n}^{h} , {\sum }_{m = 1}^{{M}_{c} + {M}_{t}} {e}_{m}^{c} ) * {p}_{avg}^{f} \\ {p}_{avg}^{f} * {\sum }_{m = 1}^{{M}_{c} + {M}_{t}} {e}_{m}^{c} = {\sum }_{m = 1}^{{M}_{c} + {M}_{t}} {e}_{m}^{c} * {p}_{m}^{c}$$

(2) Quantity Constraint of Final Distribution

$${\sum }_{n = 1}^{N} {e}_{n}^{f} = {\sum }_{m = 1}^{{M}_{c} + {M}_{t}} {e}_{m}^{c}$$

(3) Price Constraint of Final Distribution

pₙ^{f}≤pₙ^{f}≤p̅ₙ^{f}

pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

(4) Non-Negative Constraint of Final Distribution

$$\{ \begin{matrix}{e}_{n}^{f} \geq 0 \\ {p}_{n}^{f} \geq 0\end{matrix}$$

In the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} and p̅ₙ^{f} are upper and lower limits of the finally distributed electricity price, p_{avg}^{f} is a weighted average price of all trade contracts of the electricity retailer, and eₙ^{h} is actual electricity consumption of the entrusting customer in a corresponding trade period.

### BRIEF DESCRIPTION OF THE DRAWINGS

Illustrative embodiments of the present disclosure are described in detail below with reference to the figures.

FIG. 1 is a structural diagram illustrating an electricity trading system according to an embodiment of the disclosure.

FIG. 2 is a flowchart illustrating an electricity trading method according to an embodiment of the disclosure.

### DETAILED DESCRIPTION

The following describes some non-limiting embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

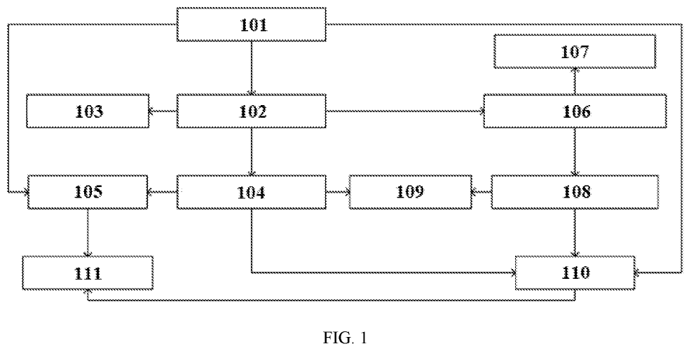

FIG. 1 is a structural diagram illustrating an electricity trading system according to an embodiment of the disclosure. In FIG. 1, (101) represents user login module; (102) represents trade unit management module; (103) represents first display module; (104) represents wholesale market trade module; (105) represents retail preliminary distribution module; (106) represents data acquisition and deviation calculation module; (107) represents second display module; (108) represents deviation transfer trade module; (109) represents third display module; (110) represents retail final distribution module; and (111) represents fourth display module

As shown in FIG. 1, an electricity retail trading system for coupling a wholesale market may include a user login module, a trade unit management module, a first display module, a wholesale market trade module, a retail preliminary distribution module, a data acquisition and deviation calculation module, a second display module, a deviation transfer trade module, a third display module, a retail final distribution module, and a fourth display module.

The user login module (101) may be configured for a user to enter login information to log in to the system. The user is authenticated to log in to the system if a verification succeeds; the user is prohibited to log in to the system if the verification fails. The user may be selected from the group consisting of an electricity selling entity, an electricity purchasing entity, and a power trading institution. The electricity purchasing entity may be selected from the group consisting of an electricity retailer, an entrusting customer, and a general customer. The power trading institution may serve as a system administrator to control a beginning and end of each step, such as a beginning and end of retail preliminary distribution, and a beginning and end of retail final distribution.

The trade unit management module (102) may be connected to the user login module 101, and the trade unit management module (102) may be configured for the selling and purchasing entities to set up and manage a bid and declaration unit to participate in a market trade. The electricity selling entity may serve as a trade unit by combining some or all units of a power plant. The general customer may serve as a trade unit by a single account or multiple accounts. The electricity retailer may serve as a trade unit by combining some or all entrusting customers.

The first display module (103) may be connected to the trade unit management module 102, and the first display module (103) may be configured for displaying the information of the bid and declaration unit set up by the electricity selling and purchasing entities.

The wholesale market trade module (104) may be connected to the trade unit management module (102) for wholesale market declaration and clearing. The electricity selling entity and the electricity purchasing entity participate in the wholesale market declaration based on a respective trade unit. The electricity selling entity may declare a quantity of electricity to supply and an intended price to sell electricity. The electricity purchasing entity may declare demand for electricity and an intended price to purchase electricity. The quantity of electricity declared by the electricity selling and purchasing entities does not exceed a bid quantity thereof. The electricity trading institution may clear the wholesale market based on the market declaration information to form a wholesale market trade result of the electricity selling and purchasing entities.

The retail preliminary distribution module (105) may be connected to the user login module (101) and the wholesale market trade module 104. The retail preliminary distribution module may be configured for the electricity retailer to distribute a quantity and price to the entrusting customer based on a wholesale market trade contract and a retail service contract with the entrusting customer before an actual electricity consumption cycle starts, so as to guide the customer's electricity consumption. The entrusting customer may query a distribution contract of the trade. Meanwhile, the preliminary distribution of the electricity retailer must meet the following requirements.

(1) Equilibrium Constraint of Preliminary Distribution

$${\sum }_{n = 1}^{N} {e}_{n}^{l} * {p}_{n}^{l} = {\sum }_{m = 1}^{{M}_{c}} {e}_{m}^{c} * {p}_{m}^{c}$$

(2) Quantity Constraint of Preliminary Distribution

$${\sum }_{n = 1}^{N} {e}_{n}^{l} = {\sum }_{m = 1}^{{M}_{c}} {e}_{m}^{c}$$

(3) Price Constraint of Preliminary Distribution

pₙ^{l}≤pₙ^{l}≤p̅ₙ^{l}

pₙ^{l}=min{p₁^{c},p₂^{c}, . . . ,p_{M}_{_{c}}^{c}}

p̅ₙ^{l}=max{p₁^{c},p₂^{c}, . . . ,p_{M}_{_{c}}^{c}}

(4) Non-Negative Constraint of Preliminary Distribution

$$\{ \begin{matrix}{e}_{n}^{l} \geq 0 \\ {p}_{n}^{l} \geq 0\end{matrix}$$

In the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, and pₙ^{l} and p̅ₙ^{l} are upper and lower limits of the distributed electricity price.

The data acquisition and deviation calculation module (106) may be connected to the trade unit management module 102, and the data acquisition and deviation calculation module (106) may be configured for acquiring actual electricity generation or consumption of the electricity selling or purchasing entity and calculating a deviation quantity between the actual electricity generation or consumption and the trade contract based on the trade unit of the electricity selling or purchasing entity. If the actual electricity generation or consumption exceeds the quantity agreed in the trade contract, an excess part forms a positive deviation. If the actual electricity generation or consumption does not reach the quantity agreed in the trade contract, a missing part forms a negative deviation.

The second display module (107) may be connected to the data acquisition and deviation calculation module 106, and the second display module (107) may be configured for displaying the acquired actual electricity generation or consumption of the electricity selling or purchasing entity and the positive or negative deviation quantity of a corresponding trade unit.

The deviation transfer trade module (108) may be connected to the data acquisition and deviation calculation module 106, and may be configured for bid, declaration, and clearing of a deviation quantity trade. After the actual electricity generation or consumption cycle ends, an electricity selling or purchasing entity with a positive deviation quantity may participate in a deviation transfer trade with an electricity selling or purchasing entity with a negative deviation quantity. A party with a positive deviation quantity may declare a purchase trade contract to reduce the positive deviation, and a party with a negative deviation quantity may declare a sales trade contract to reduce the negative deviation. In addition, the total trade quantity of the electricity selling or purchasing entity does not exceed the deviation quantity thereof. The electricity trading institution may clear a deviation transfer market to form a deviation transfer trade result.

The third display module (109) may be connected to the wholesale market trade module (104) and the deviation transfer trade module 108, and the third display module (109) may be configured for displaying a trade result of the electricity selling or purchasing entity in the wholesale market and the deviation transfer market.

The retail final distribution module (110) may be connected with the user login module 101, the wholesale market trade module 104, and the deviation transfer trade module 108. A wholesale market trade contract and a deviation transfer market trade contract of the electricity retailer jointly form a deviation-adjusted trade contract thereof. The electricity retailer may distribute a final quantity and price to the entrusting customer based on the deviation-adjusted trade contract to facilitate the smooth development of subsequent financial settlement and other services. Meanwhile, the final distribution of the electricity retailer must meet the following requirements.

(1) Equilibrium Constraint of Final Distribution

$${\sum }_{n = 1}^{N} min ( {e}_{n}^{h} , {e}_{n}^{f} ) * {p}_{n}^{f} = min ( {\sum }_{n = 1}^{N} {e}_{n}^{h} , {\sum }_{m = 1}^{{M}_{c} + {M}_{t}} {e}_{m}^{c} ) * {p}_{avg}^{f} \\ {p}_{avg}^{f} * {\sum }_{m = 1}^{{M}_{c} + {M}_{t}} {e}_{m}^{c} = {\sum }_{m = 1}^{{M}_{c} + {M}_{t}} {e}_{m}^{c} * {p}_{m}^{c}$$

(2) Quantity Constraint of Final Distribution

$${\sum }_{n = 1}^{N} {e}_{n}^{f} = {\sum }_{m = 1}^{{M}_{c} + {M}_{t}} {e}_{m}^{c}$$

(3) Price Constraint of Final Distribution

pₙ^{f}≤pₙ^{f}≤p̅ₙ^{f}

pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

(4) Non-Negative Constraint of Final Distribution

$$\{ \begin{matrix}{e}_{n}^{f} \geq 0 \\ {p}_{n}^{f} \geq 0\end{matrix}$$

In the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} and p̅ₙ^{f} are upper and lower limits of the finally distributed electricity price, p_{avg}^{f} is a weighted average price of all trade contracts of the electricity retailer, and eₙ^{h} is actual electricity consumption of the entrusting customer in a corresponding trading period.

The fourth display module (111) may be connected to the retail preliminary distribution module (105) and the retail final distribution module 110, and the fourth display module (111) may be configured for displaying a retail preliminary distribution result and a retail final distribution result of the electricity retailer for the entrusting customer.

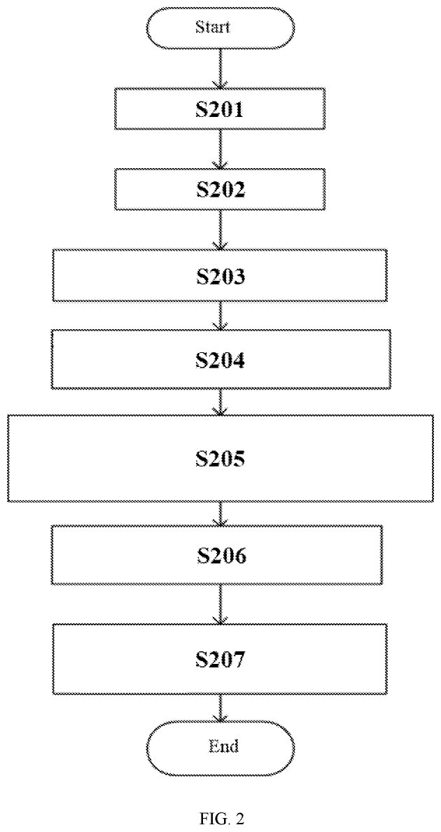

FIG. 2 is a flowchart illustrating an electricity trading method according to an embodiment of the disclosure. As shown in FIG. 2, an electricity retail trading method for coupling a wholesale market by using the electricity retail trading system for coupling a wholesale market may include the following steps 201-207: user login, trade unit management, wholesale market trade, retail preliminary distribution of electricity retailer, data acquisition and deviation calculation, deviation transfer trade, and retail final distribution of electricity retailer.

Step S201: User login. A user enters login information through a user login module 101. The user is authenticated to log in to the system if a verification succeeds; the user is prohibited to log in to the system if the verification fails. The user may be selected from the group consisting of an electricity selling entity, an electricity purchasing entity, and a power trading institution. The electricity purchasing entity may be selected from the group consisting of an electricity retailer, an entrusting customer, and a general customer. The power trading institution may serve as a system administrator to control a beginning and end of each step, such as a beginning and end of retail preliminary distribution, and a beginning and end of retail final distribution.

Step S202: Trade unit management. The electricity selling and purchasing entities may set up and manage a bid and declaration unit to participate in a market trade. The electricity selling entity may serve as a trade unit by combining some or all units of a power plant. The general customer may serve as a trade unit by a single account or multiple accounts. The electricity retailer may serve as a trade unit by combining some or all entrusting customers. A first display module (103) displays the information of the bid and declaration unit set up by the electricity selling and purchasing entities.

Step S203: Wholesale market trade. The selling and purchasing entities participate in the wholesale market declaration based on a respective trade unit. The electricity selling entity may declare a quantity of electricity to supply and an intended price to sell electricity. The electricity purchasing entity may declare demand for electricity and an intended price to purchase electricity. The quantity of electricity declared by the electricity selling and purchasing entities does not exceed a bid quantity thereof. The electricity trading institution may clear the wholesale market based on the market declaration information to form a wholesale market trade result of the electricity selling and purchasing entities, which is displayed on a third display module 109.

Step S204: Retail preliminary distribution of electricity retailer. Before an actual electricity consumption cycle starts, the electricity retailer may distribute a quantity and price to the entrusting customer based on a wholesale market trade contract and a retail service contract with the entrusting customer, so as to guide the customer's electricity consumption. The entrusting customer may query a distribution contract of the trade. A fourth display module (111) displays a retail preliminary distribution result. Meanwhile, the preliminary distribution of the electricity retailer must meet the following requirements.

(1) Equilibrium Constraint of Preliminary Distribution

$${\sum }_{n = 1}^{N} {e}_{n}^{l} * {p}_{n}^{l} = {\sum }_{m = 1}^{{M}_{c}} {e}_{m}^{c} * {p}_{m}^{c}$$

(2) Quantity Constraint of Preliminary Distribution

$${\sum }_{n = 1}^{N} {e}_{n}^{l} = {\sum }_{m = 1}^{{M}_{c}} {e}_{m}^{c}$$

(3) Price Constraint of Preliminary Distribution

pₙ^{l}≤pₙ^{l}≤p̅ₙ^{l}

pₙ^{l}=min{p₁^{c},p₂^{c}, . . . ,p_{M}_{_{c}}^{c}}

p̅ₙ^{l}=max{p₁^{c},p₂^{c}, . . . ,p_{M}_{_{c}}^{c}}

(4) Non-Negative Constraint of Preliminary Distribution

$$\{ \begin{matrix}{e}_{n}^{l} \geq 0 \\ {p}_{n}^{l} \geq 0\end{matrix}$$

In the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, and pₙ^{l} and p̅ₙ^{l} are upper and lower limits of the distributed electricity price.

Step S205: Data acquisition and deviation calculation. Actual electricity generation or consumption of the electricity selling or purchasing entity is acquired, and a deviation quantity between the actual electricity generation or consumption and the trade contract is calculated based on the trade unit of the electricity selling or purchasing entity. If the actual electricity generation or consumption exceeds the quantity agreed in the trade contract, an excess part forms a positive deviation. If the actual electricity generation or consumption does not reach the quantity agreed in the trade contract, a missing part forms a negative deviation. A second display module (107) displays the acquired actual electricity generation or consumption of the electricity selling or purchasing entity and the positive or negative deviation quantity of a corresponding trade unit.

Step S206: Deviation transfer trade. After the actual electricity generation or consumption cycle ends, an electricity selling or purchasing entity with a positive deviation quantity may participate in a deviation quantity transfer trade with an electricity selling or purchasing entity with a negative deviation quantity. A party with a positive deviation quantity may declare a purchase trade contract to reduce the positive deviation, and a party with a negative deviation quantity may declare a sales trade contract to reduce the negative deviation. In addition, the total trade quantity of the electricity selling or purchasing entity does not exceed the deviation quantity thereof. The electricity trading institution may clear a deviation transfer market to form a deviation transfer trade result, which is shown on a third display module 109.

Step S207: Retail final distribution of electricity retailer. A wholesale market trade contract and a deviation transfer market trade contract of the electricity retailer jointly form a deviation-adjusted trade contract thereof. The electricity retailer may distribute a final quantity and price to the entrusting customer based on the deviation-adjusted trade contract to facilitate the smooth development of subsequent financial settlement and other services. A fourth display module (111) displays a retail final distribution result. Meanwhile, the final distribution of the electricity retailer must meet the following requirements.

(1) Equilibrium Constraint of Final Distribution

$${\sum }_{n = 1}^{N} min ( {e}_{n}^{h} , {e}_{n}^{f} ) * {p}_{n}^{f} = min ( {\sum }_{n = 1}^{N} {e}_{n}^{h} , {\sum }_{m = 1}^{{M}_{c} + {M}_{t}} {e}_{m}^{c} ) * {p}_{avg}^{f}$$

$${p}_{avg}^{f} * {\sum }_{m = 1}^{{M}_{c} + {M}_{t}} {e}_{m}^{c} = {\sum }_{m = 1}^{{M}_{c} + {M}_{t}} {e}_{m}^{c} * {p}_{m}^{c}$$

(2) Quantity Constraint of Final Distribution

$${\sum }_{n = 1}^{N} {e}_{n}^{f} = {\sum }_{m = 1}^{{M}_{c} + {M}_{t}} {e}_{m}^{c}$$

(3) Price Constraint of Final Distribution

pₙ^{f}≤pₙ^{f}≤p̅ₙ^{f}

pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

(4) Non-Negative Constraint of Final Distribution

$$\{ \begin{matrix}{e}_{n}^{f} \geq 0 \\ {p}_{n}^{f} \geq 0\end{matrix}$$

In the above requirements, Mₜ is a number of trade contracts won by the electricity retailer in the deviation transfer market, pₙ^{f} and eₙ^{f} are contract quantity and price of electricity finally distributed to entrusting customer n, pₙ^{f} and p̅ₙ^{f} are upper and lower limits of the finally distributed electricity price, p_{avg}^{f} is a weighted average price of all trade contracts of the electricity retailer, and eₙ^{h} is actual electricity consumption of the entrusting customer in a corresponding trading period.

The system and method of the disclosure may be configured for daily, monthly, and/or annual trades without limitations.

Usually, a power exchange center publishes market disclosure information to various market entities before a trade starts, and publishes information such as a schedule of various trades in the wholesale and retail markets. The trading system of the disclosure may be implemented according to the disclosed schedule. The electricity selling and purchasing entities log in to the system to manage the trade unit through the trade unit management module 102, and the information of the unit is displayed in the first display module 103. The trade unit may be set up as shown in the following Table 1.

TABLE 1
Composition of a trade unit

| Market entity | Trade unit | Unit composition |
|---|---|---|
| Electricity retailer A | PA-01 | Entrusting customer b1 |
| | | Entrusting customer b2 |
| | | Entrusting customer b3 |
| | | Entrusting customer b4 |
| Power plant S1 | S1-01 | Unit S1#1 |
| Power plant S2 | S2-01 | Unit S2#1 |
| | | Unit S2#2 |
| Power plant S3 | S3-01 | Unit S3#1 |
| Customer B1 | B1-01 | Account 001 |

The electricity selling and purchasing entities participate in the wholesale market with the preset trade unit to bid and declare in the market. The electricity trading institution collects all declaration information, and may clear the market to form a wholesale market trade result, which may be displayed in the third display module 109. In some embodiments, the wholesale market adopts a centralized matching method, the trade price may be an average price declared by the electricity selling and purchasing entities. The declaration and clearing records of the electricity selling and purchasing entities are shown in the following Table 2, and the wholesale market trade details of the electricity retailer are shown in the following Table 3 (the unit of quantity is 10,000 kWh and the unit of price is Yuan/kWh).

TABLE 2
Declaration and clearing records of electricity selling and
purchasing entities

| | | | | Accu- | Weight- | Accu- | Weight- |
|---|---|---|---|---|---|---|---|
| | | | | mulated | ed | mulated | ed |
| Market | Trade | | Bid | declared | declared | trade | trade |
| entity | unit | Role | quantity | quantity | price | quantity | price |
| Electricity | PA- | Pur- | 1000 | 900 | 0.27 | 900 | 0.26 |
| retailer A | 01 | chase | | | | | |
| Power | S1- | Sell | 600 | 500 | 0.26 | 300 | 0.265 |
| plant S1 | 01 | | | | | | |
| Power | S2- | Sell | 300 | 300 | 0.25 | 300 | 0.26 |
| plant S2 | 01 | | | | | | |
| Power | S3- | Sell | 450 | 400 | 0.24 | 400 | 0.25875 |
| plant S3 | 01 | | | | | | |
| Customer | B1- | Pur- | 110 | 100 | 0.3 | 100 | 0.27 |
| B1 | 01 | chase | | | | | |

TABLE 3
Wholesale market trade details of electricity retailer

| | Electricity | Trade | | Power | Trade | | Trade | Trade |
|---|---|---|---|---|---|---|---|---|
| SN | retailer | unit | Role | plant | unit | Role | quantity | price |
| 1 | Electricity | PA-01 | Pur- | Power | S1-01 | Sell | 300 | 0.265 |
| | retailer A | | chase | plant | | | | |
| | | | | S1 | | | | |
| 2 | Electricity | PA-01 | Pur- | Power | S2-01 | Sell | 300 | 0.26 |
| | retailer A | | chase | plant | | | | |
| | | | | S2 | | | | |
| 3 | Electricity | PA-01 | Pur- | Power | S3-01 | Sell | 300 | 0.255 |
| | retailer A | | chase | plant | | | | |
| | | | | S3 | | | | |

Before an actual electricity consumption cycle starts, the electricity retailer may distribute a quantity and price to the entrusting customer based on a wholesale market trade contract and a retail service contract with the entrusting customer, so as to guide the customer's electricity consumption. The entrusting customer may query a distribution contract of the trade. Meanwhile, the preliminary distribution of the electricity retailer must meet the following requirements.

(1) Equilibrium Constraint of Preliminary Distribution

$${\sum }_{n = 1}^{N} {e}_{n}^{l} * {p}_{n}^{l} = {\sum }_{m = 1}^{{M}_{c}} {e}_{m}^{c} * {p}_{m}^{c}$$

(2) Quantity Constraint of Preliminary Distribution

$${\sum }_{n = 1}^{N} {e}_{n}^{l} = {\sum }_{m = 1}^{{M}_{c}} {e}_{m}^{c}$$

(3) Price Constraint of Preliminary Distribution

pₙ^{l}≤pₙ^{l}≤p̅ₙ^{l}

pₙ^{l}=min{p₁^{c},p₂^{c}, . . . ,p_{M}_{_{c}}^{c}}

p̅ₙ^{l}=max{p₁^{c},p₂^{c}, . . . ,p_{M}_{_{c}}^{c}}

(4) Non-Negative Constraint of Preliminary Distribution

$$\{ \begin{matrix}{e}_{n}^{l} \geq 0 \\ {p}_{n}^{l} \geq 0\end{matrix}$$

In the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, and pₙ^{l} and p̅ₙ^{l} are upper and lower limits of the distributed electricity price.

According to the above distribution rules, in the wholesale market, the total trade quantity of the electricity retailer A may be 9 million KWh, and the average trade price is 0.26 Yuan/KWh. The retail preliminary distribution result of the electricity retailer A is shown in the following Table 4 (the unit of quantity is 10,000 kWh and the unit of price is Yuan/kWh).

TABLE 4
Retail preliminary distribution result

| S | | Trade | | Preliminarily | Preliminarily |
|---|---|---|---|---|---|
| N | Electricity retailer | unit | Entrusting customer | distributed quantity | distributed price |
| 1 | Electricity retailer A | PA-01 | Entrusting customer b1 | 200 | 0.258 |
| 2 | Electricity retailer A | PA-01 | Entrusting customer b2 | 400 | 0.26 |
| 3 | Electricity retailer A | PA-01 | Entrusting customer b3 | 100 | 0.26 |
| 4 | Electricity retailer A | PA-01 | Entrusting customer b4 | 200 | 0.262 |

After the actual electricity generation or consumption cycle ends, the actual electricity generation or consumption of the electricity selling or purchasing entity is acquired, and a deviation quantity between the actual electricity generation or consumption and the trade contract is calculated based on the trade unit of the electricity selling or purchasing entity. If the actual electricity generation or consumption exceeds the quantity agreed in the trade contract, an excess part forms a positive deviation. If the actual electricity generation or consumption does not reach the quantity agreed in the trade contract, a missing part forms a negative deviation. Following Table 5 shows the deviation of the electricity selling and purchasing entities upon the completion of contract. The actual electricity consumption of the electricity retailer is the sum of the actual electricity consumption of the entrusting customers thereof (the unit of quantity is 10,000 kWh).

TABLE 5
Deviation of electricity selling and purchasing entities
upon the completion of contract

| | | Accumulated | Actual electricity | Positive | Negative |
|---|---|---|---|---|---|
| Market entity | Trade unit | trade quantity | generation/consumption | deviation | deviation |
| Electricity retailer A | PA-01 | 900 | 860 | 0 | 40 |
| Power plant S1 | S1-01 | 300 | 280 | 0 | 20 |
| Power plant S2 | S2-01 | 300 | 320 | 20 | 0 |
| Power plant S3 | S3-01 | 400 | 380 | 0 | 20 |
| Customer B1 | B1-01 | 100 | 120 | 20 | 0 |

An electricity selling or purchasing entity with a positive deviation quantity may participate in a deviation transfer trade with an electricity selling or purchasing entity with a negative deviation quantity. A party with a positive deviation quantity may declare a purchase trade contract to reduce the positive deviation, and a party with a negative deviation quantity may declare a sales trade contract to reduce the negative deviation. In addition, the total trade quantity of the electricity selling or purchasing entity does not exceed the deviation quantity thereof. The electricity trading institution may clear a deviation transfer market to form a deviation transfer trade result, which is shown on a third display module 109. Assuming that the transfer of deviation on the electricity consumption side is conducted through bilateral negotiation, the declaration and clearing results of the bidding entities of the trade are shown in the following Table 6, and the deviation transfer trade details of the electricity retailer are shown in the following Table 7 (the unit of quantity is 10,000 kWh and the unit of price is Yuan/kWh).

TABLE 6
Declaration and clearing results of bidding entities

| | | | | Accu- | Accu- | |
|---|---|---|---|---|---|---|
| | | | | mulated | mulated | Weighted |
| Market | Trade | | Bid | declared | trade | trade |
| entity | unit | Role | quantity | quantity | quantity | price |
| Electricity | PA- | Sell | 40 | 20 | 20 | 0.26 |
| retailer A | 01 | | | | | |
| Customer | B1- | Purchase | 20 | 20 | 20 | 0.26 |
| B1 | 01 | | | | | |

TABLE 7
Deviation transfer trade details of electricity retailer

| | Electricity | | | Electricity | | | | |
|---|---|---|---|---|---|---|---|---|
| | retailer/ | Trade | | retailer/ | Trade | | Trade | Trade |
| SN | customer | unit | Role | customer | unit | Role | quantity | price |
| 1 | Electricity | PA- | Sell | Customer | B1- | Pur- | 20 | 0.26 |
| | retailer A | 01 | | B1 | 01 | chase | | |

A wholesale market trade contract and a deviation transfer market trade contract of the electricity retailer jointly form a deviation-adjusted trade contract thereof. The electricity retailer may distribute a final quantity and price to the entrusting customer based on the deviation-adjusted trade contract to facilitate the smooth development of subsequent financial settlement and other services. Meanwhile, the final distribution of the electricity retailer must meet the following requirements.

(1) Equilibrium Constraint of Final Distribution

$${\sum }_{n = 1}^{N} min ( {e}_{n}^{h} , {e}_{n}^{f} ) * {p}_{n}^{f} = min ( {\sum }_{n = 1}^{N} {e}_{n}^{h} , {\sum }_{m = 1}^{{M}_{c} + {M}_{t}} {e}_{m}^{c} ) * {p}_{avg}^{f}$$

$${p}_{avg}^{f} * {\sum }_{m = 1}^{{M}_{c} + {M}_{t}} {e}_{m}^{c} = {\sum }_{m = 1}^{{M}_{c} + {M}_{t}} {e}_{m}^{c} * {p}_{m}^{c}$$

(2) Quantity Constraint of Final Distribution

$${\sum }_{n = 1}^{N} {e}_{n}^{f} = {\sum }_{m = 1}^{{M}_{c} + {M}_{t}} {e}_{m}^{c}$$

(3) Price Constraint of Final Distribution

pₙ^{f}≤pₙ^{f}≤p̅ₙ^{f}

pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}

(4) Non-Negative Constraint of Final Distribution

$$\{ \begin{matrix}{e}_{n}^{f} \geq 0 \\ {p}_{n}^{f} \geq 0\end{matrix}$$

In the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} and p̅ₙ^{f} are upper and lower limits of the finally distributed electricity price, p_{avg}^{f} is a weighted average price of all trade contracts of the electricity retailer, and eₙ^{h} is actual electricity consumption of the entrusting customer in a corresponding trading period.

According to the above distribution rules, in the wholesale market, the total trade quantity of the electricity retailer A is 9 million KWh, and the average trade price is 0.26 Yuan/KWh. In the deviation transfer market, the trade quantity is 0.2 million kWh and the trade price is 0.26 Yuan/KWh. The retail final distribution result is shown in the following Table 8 (the unit of quantity is 10,000 kWh and the unit of price is Yuan/kWh).

TABLE 8
Retail final distribution result

| | | | | Preliminarily | Actual | Finally | Finally |
|---|---|---|---|---|---|---|---|
| | Electricity | | Entrusting | distributed | electricity | distributed | distributed |
| SN | retailer | Trade unit | customer | quantity | consumption | quantity | price |
| 1 | Electricity | PA-01 | Entrusting | 200 | 185 | 189.3023 | 0.265 |
| | retailer A | | customer b1 | | | | |
| 2 | Electricity | PA-01 | Entrusting | 400 | 390 | 399.0698 | 0.255 |
| | retailer A | | customer b2 | | | | |
| 3 | Electricity | PA-01 | Entrusting | 100 | 80 | 81.8605 | 0.26 |
| | retailer A | | customer b3 | | | | |
| 4 | Electricity | PA-01 | Entrusting | 200 | 205 | 209.7674 | 0.265 |
| | retailer A | | customer b4 | | | | |

Various embodiments of the disclosure may have one or more of the following effects.

In some embodiments, the disclosure provides an electricity retail trading system and method for coupling a wholesale market, which may help to solve the deficiencies of the prior art. The disclosure may implement the organic connection between a wholesale market and a retail market.

In other embodiments, an electricity retailer may adjust a retail trade distribution contract with an entrusting customer by performing a preliminary distribution before an electricity generation/consumption cycle starts and a final distribution after the electricity generation/consumption cycle ends. As a result, the disclosure may help to reduce the risk of deviation assessment, meet the electricity demand of the entrusting customer to the greatest extent, and promote the effective execution of a retail service contract.

In further embodiments, the disclosure may implement the adjustment of a distribution contract, which may help to reduce the risk of deviation assessment, meet the electricity demand of an entrusting customer to the greatest extent, and promote the effective execution of a retail service contract.

In some embodiments, the disclosure may provide electricity retail trading systems and methods for coupling a wholesale market. The disclosure may help to solve the problems in prior art, meet business needs, and promote further development of the electricity retail market.

In other embodiments, the disclosure may provide electricity retail trading systems and methods for coupling a wholesale market, which may be reusable and suitable for daily, monthly, and/or annual electricity trades.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. An electricity retail trading system for coupling a wholesale market, comprising: a user login module (101), a trade unit management module (102), a first display module (103), a wholesale market trade module (104), a retail preliminary distribution module (105), a data acquisition and deviation calculation module (106), a second display module (107), a deviation transfer trade module (108), a third display module (109), a retail final distribution module (110), and a fourth display module (111), wherein:
the user login module (101) is configured for a user to enter login information to log in to the system, wherein:
the user is authenticated to log in to the system if a verification succeeds;
the user is prohibited to log in to the system if the verification fails;
the user is selected from the group consisting of an electricity selling entity, an electricity purchasing entity, and a power trading institution;
the electricity purchasing entity is selected from the group consisting of an electricity retailer, an entrusting customer, and a general customer;
the power trading institution serves as a system administrator to control a beginning and end of each step;
the trade unit management module (102) is connected to the user login module (101), and the trade unit management module (102) is configured for the selling and purchasing entities to set up and manage a bid and declaration unit to participate in a market trade, wherein:
the electricity selling entity serves as a trade unit by combining some or all units of a power plant; among the electricity purchasing entity,
the general customer serves as a trade unit by a single account or multiple accounts, and
the electricity retailer serves as a trade unit by combining some or all entrusting customers;
the first display module (103) is connected to the trade unit management module (102), and the first display module (103) is configured for displaying the information of the bid and declaration unit set up by the electricity selling and purchasing entities;
the wholesale market trade module (104) is connected to the trade unit management module (102) for wholesale market declaration and clearing, wherein:
the selling and purchasing entities participate in the wholesale market declaration based on a respective trade unit,
the electricity selling entity declares a quantity of electricity to supply and an intended price to sell electricity,
the electricity purchasing entity declares demand for electricity and an intended price to purchase electricity,
the quantity of electricity declared by the electricity selling and purchasing entities does not exceed a bid quantity thereof, and
the electricity trading institution clears the wholesale market based on the market declaration information to form a wholesale market trade result of the electricity selling and purchasing entities;
the retail preliminary distribution module (105) is connected to the user login module (101) and the wholesale market trade module (104), wherein:
the retail preliminary distribution module is configured for the electricity retailer to distribute a quantity and price to the entrusting customer based on a wholesale market trade contract and a retail service contract with the entrusting customer before an actual electricity consumption cycle starts, so as to guide the customer's electricity consumption,
the entrusting customer queries a distribution contract of the trade,
the quantity and price of electricity are agreed in the contract,
the distribution completed by the retail preliminary distribution module (105) is preliminary distribution, and
the preliminary distribution of the electricity retailer meets the following requirements:
(1) equilibrium constraint of preliminary distribution
Σₙ₌₁^{N}eₙ^{l}*pₙ^{l}=Σₘ₌₁^{M}^{_{c}}eₘ^{c}*pₘ^{c},
(2) quantity constraint of preliminary distribution
Σₙ₌₁^{N}eₙ^{l}=Σₘ₌₁^{M}^{_{c}}eₘ^{c},
(3) price constraint of preliminary distribution
pₙ^{l}≤pₙ^{l}≤p̅ₙ^{l},
pₙ^{l}=min{p₁^{c},p₂^{c}, . . . ,p_{M}_{_{c}}^{c}}, and
p̅ₙ^{l}=max{p₁^{c},p₂^{c}, . . . ,p_{M}_{_{c}}^{c}}, and
(4) non-negative constraint of preliminary distribution
$$\{ \begin{matrix}{e}_{n}^{l} \geq 0 \\ {p}_{n}^{l} \geq 0\end{matrix} ,$$
in the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, pₙ^{l} and p̅ₙ^{l} are upper and lower limits of the distributed electricity price, and p₁^{c}, p₂^{c}, . . . , p_{M}_{_{c}}^{c} are distributed electricity prices;
the data acquisition and deviation calculation module (106) is connected to the trade unit management module (102), wherein:
the data acquisition and deviation calculation module (106) is configured for acquiring actual electricity generation or consumption of the electricity selling or purchasing entity and calculating a deviation quantity between the actual electricity generation or consumption and the trade contract based on the trade unit of the electricity selling or purchasing entity,
if the actual electricity generation or consumption exceeds the quantity agreed in the trade contract, an excess part forms a positive deviation, and
if the actual electricity generation or consumption does not reach the quantity agreed in the trade contract, a missing part forms a negative deviation;
the second display module (107) is connected to the data acquisition and deviation calculation module (106), and the second display module (107) is configured for displaying the acquired actual electricity generation or consumption of the electricity selling or purchasing entity and the positive or negative deviation quantity of a corresponding trade unit;
the deviation transfer trade module (108) is connected to the data acquisition and deviation calculation module (106), and is configured for bid, declaration and clearing of a deviation quantity trade, wherein:
after the actual electricity generation or consumption cycle ends, an electricity selling or purchasing entity with a positive deviation quantity participates in a deviation transfer trade with an electricity selling or purchasing entity with a negative deviation quantity,
a party with a positive deviation quantity declares a purchase trade contract to reduce the positive deviation,
a party with a negative deviation quantity declares a sales trade contract to reduce the negative deviation,
a total trade quantity of the electricity purchasing entity or selling entity does not exceed the deviation quantity thereof, and
the electricity trading institution clears a deviation transfer market to form a deviation transfer trade result;
the third display module (109) is connected to the wholesale market trade module (104) and the deviation transfer trade module (108), and the third display module (109) is configured for displaying a trade result of the electricity selling or purchasing entity in the wholesale market and the deviation transfer market;
the retail final distribution module (110) is connected with the user login module (101), the wholesale market trade module (104), and the deviation transfer trade module (108), wherein:
a wholesale market trade contract and a deviation transfer market trade contract of the electricity retailer jointly form a deviation-adjusted trade contract thereof,
the electricity retailer distributes a final quantity and price to the entrusting customer based on the deviation-adjusted trade contract to facilitate the smooth development of subsequent financial settlement and other services,
the distribution completed by the retail final distribution module (110) is final distribution, and
the final distribution of the electricity retailer meets the following requirements:
(1) equilibrium constraint of final distribution
Σₙ₌₁^{N}min(eₙ^{h},eₙ^{f})*pₙ^{f}=min(Σₙ₌₁^{N}eₙ^{h},Σₘ₌₁^{M}^{_{c}}^{+M}^{ₜ}eₘ^{c})*p_{avg}^{f}, and
p_{avg}^{f}*Σₘ₌₁^{M}^{_{c}}^{+M}^{ₜ}eₘ^{c}=Σₘ₌₁^{M}^{_{c}}^{+M}^{ₜ}eₘ^{c}*pₘ^{c},
(2) quantity constraint of final distribution
Σₙ₌₁^{N}eₙ^{f}=Σₘ₌₁^{M}^{_{c}}^{+M}^{ₜ}eₘ^{c},
(3) price constraint of final distribution
pₙ^{f}≤pₙ^{f}≤p̅ₙ^{f},
pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}, and
p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}, and
(4) non-negative constraint of final distribution
$$\{ \begin{matrix}{e}_{n}^{f} \geq 0 \\ {p}_{n}^{f} \geq 0\end{matrix} ,$$
and
in the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} is a finally distributed electricity price, pₙ^{f} and p̅ₙ^{f} are upper and lower limits of the finally distributed electricity price, p₁^{c}, p₂^{c}, . . . , p_{M}_{_{c}}^{c}, p_{M}_{_{c}}₊₁^{c}, . . . , p_{M}_{_{c}}_{+M}_{ₜ}^{c} are finally distributed electricity prices, p_{avg}^{f} is a weighted average price of all trade contracts of the electricity retailer, and eₙ^{h} is actual electricity consumption of the entrusting customer in a corresponding trade period; and
the fourth display module (111) is connected to the retail preliminary distribution module (105) and the retail final distribution module (110), and the fourth display module (111) is configured for displaying a retail preliminary distribution result and a retail final distribution result of the electricity retailer for the entrusting customer.

2. An electricity retail trading method for coupling a wholesale market using an electricity retail trading system, comprising the steps of:
(a) user login: a user enters login information through a user login module (101) for a verification, wherein:
the user is authenticated to log in to the system if the verification succeeds,
the user is prohibited to log in to the system if the verification fails,
the user is selected from the group consisting of an electricity selling entity, an electricity purchasing entity, and a power trading institution,
the electricity purchasing entity is selected from the group consisting of an electricity retailer, an entrusting customer, and a general customer, and
the power trading institution serves as a system administrator to control a beginning and end of each step;
(b) trade unit management: the electricity selling and purchasing entities set up and manage a bid and declaration unit to participate in a market trade, wherein
the electricity selling entity serves as a trade unit by combining some or all units of a power plant,
the general customer serves as a trade unit by a single account or multiple accounts,
the electricity retailer serves as a trade unit by combining some or all entrusting customers, and
a first display module (103) displays the information of the bid and declaration unit set up by the electricity selling and purchasing entities;
(c) declaration and clearing of wholesale market trade: the selling and purchasing entities participate in the wholesale market declaration based on a respective trade unit, wherein:
the electricity selling entity declares a quantity of electricity to supply and an intended price to sell electricity,
the electricity purchasing entity declares demand for electricity and an intended price to purchase electricity,
the quantity of electricity declared by the electricity selling and purchasing entities does not exceed a bid quantity thereof,
the electricity trading institution clears the wholesale market based on the market declaration information to form a wholesale market trade result of the electricity selling and purchasing entities, and
the wholesale market trade result of the electricity selling and purchasing entities is displayed on a third display module (109);
(d) retail preliminary distribution of electricity retailer: before an actual electricity consumption cycle starts, the electricity retailer distributes a quantity and price to the entrusting customer based on a wholesale market trade contract and a retail service contract with the entrusting customer, so as to guide the customer's electricity consumption, wherein:
the entrusting customer queries a distribution contract of the trade,
a fourth display module (111) displays a retail preliminary distribution result, and
the preliminary distribution of the electricity retailer meets the following requirements:
(1) equilibrium constraint of preliminary distribution
Σₙ₌₁^{N}eₙ^{l}*pₙ^{l}=Σₘ₌₁^{M}^{_{c}}eₘ^{c}*pₘ^{c},
(2) quantity constraint of preliminary distribution
$${\sum }_{n = 1}^{N} {e}_{n}^{l} = {\sum }_{m = 1}^{{M}_{c}} {e}_{m}^{c}$$
(3) price constraint of preliminary distribution
pₙ^{l}≤pₙ^{l}≤p̅ₙ^{l}
pₙ^{l}=min{p₁^{c},p₂^{c}, . . . ,p_{M}_{_{c}}^{c}}
p̅ₙ^{l}=max{p₁^{c},p₂^{c}, . . . ,p_{M}_{_{c}}^{c}}
(4) non-negative constraint of preliminary distribution
$$\{ \begin{matrix}{e}_{n}^{l} \geq 0 \\ {p}_{n}^{l} \geq 0\end{matrix}$$
in the above requirements, N is a number of entrusting customers of the electricity retailer, M_{c} is a number of trade contracts won by the electricity retailer in the wholesale market, eₙ^{l} and pₙ^{l} are contract quantity and price of electricity distributed to entrusting customer n, eₘ^{c} and pₘ^{c} are quantity and price of electricity agreed in contract m, and pₙ^{l} and p̅ₙ^{l} are upper and lower limits of the distributed electricity price;
(e): data acquisition and deviation quantity calculation, wherein:
actual electricity generation or consumption of the electricity selling or purchasing entity is acquired,
a deviation quantity between the actual electricity generation or consumption and the trade contract is calculated based on the trade unit of the electricity selling or purchasing entity,
if the actual electricity generation or consumption exceeds the quantity agreed in the trade contract, an excess part forms a positive deviation, and
if the actual electricity generation or consumption does not reach the quantity agreed in the trade contract, a missing part forms a negative deviation, and
a second display module (107) displays the acquired actual electricity generation or consumption of the electricity selling or purchasing entity and the positive or negative deviation quantity of a corresponding trade unit;
(f) declaration and clearing of deviation transfer market trade: after the actual electricity generation or consumption cycle ends, an electricity selling or purchasing entity with a positive deviation quantity participates in a deviation transfer trade with an electricity selling or purchasing entity with a negative deviation quantity, wherein:
a party with a positive deviation quantity declares a purchase trade contract to reduce the positive deviation,
a party with a negative deviation quantity declares a sales trade contract to reduce the negative deviation; a total trade quantity of the electricity purchasing entity or selling entity does not exceed the deviation quantity thereof,
the electricity trading institution clears a deviation transfer market to form a deviation transfer trade result, and
the deviation transfer trade result is displayed on the third display module (109); and
(g) retail final distribution of electricity retailer: a wholesale market trade contract and a deviation transfer market trade contract of the electricity retailer jointly form a deviation-adjusted trade contract thereof, wherein:
the electricity retailer distributes a final quantity and price to the entrusting customer based on the deviation-adjusted trade contract to facilitate the smooth development of subsequent financial settlement and other services,
the fourth display module (111) displays a retail final distribution result, and
the final distribution of the electricity retailer meets the following requirements,
(1) equilibrium constraint of final distribution
Σₙ₌₁^{N}min(eₙ^{h},eₙ^{f})*pₙ^{f}=min(Σₙ₌₁^{N}eₙ^{h},Σₘ₌₁^{M}^{_{c}}^{+M}^{ₜ}eₘ^{c})*p_{avg}^{f}, and
p_{avg}^{f}*Σₘ₌₁^{M}^{_{c}}^{+M}^{ₜ}eₘ^{c}=Σₘ₌₁^{M}^{_{c}}^{+M}^{ₜ}eₘ^{c}*pₘ^{c},
(2) quantity constraint of final distribution
Σₙ₌₁^{N}eₙ^{f}=Σₘ₌₁^{M}^{_{c}}^{+M}^{ₜ}eₘ^{c},
(3) price constraint of final distribution
pₙ^{f}≤pₙ^{f}≤p̅ₙ^{f},
pₙ^{f}=min{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}, and
p̅ₙ^{l}=max{p₁^{c},p₂^{c}, . . . ,p_{M}_{_{c}}^{c},p_{M}_{_{c}}₊₁^{c}, . . . ,p_{M}_{_{c}}_{+M}_{ₜ}^{c}}, and
(4) non-negative constraint of final distribution
$$\{ \begin{matrix}{e}_{n}^{f} \geq 0 \\ {p}_{n}^{f} \geq 0\end{matrix} ,$$
and
in the above requirements, Mₜ is a number of trade contracts won by the electricity retailer in the deviation transfer market, eₙ^{f} and pₙ^{f} are contract quantity and price of electricity finally distributed to entrusting customer n, pₙ^{f} and p̅ₙ^{f} are upper and lower limits of the finally distributed electricity price, p_{avg}^{f} is a weighted average price of all trade contracts of the electricity retailer, and eₙ^{h} is actual electricity consumption of the entrusting customer in a corresponding trade period.
